(19) United States
(12) Patent Application Publication
(10) Pub. No.: US 2003/0062777 A1
(43) Pub. Date: Apr. 3, 2003

(54) Computerized Table with alarm

(76) Inventor: Mauricio Bohrer Oppitz, Porto Alegre (BR)

Correspondence Address: Clifford Kraft, 320 Robin Hill Dr., Naperville, IL, 60540, US

(21) Appl. No.: 09/968,600

(22) Filed: Oct. 1, 2001

(51) Int. Cl. H01H 1/00

(52) U.S. Cl. 307/112

(57) ABSTRACT

An integrated structure of a computerized table with alarm aiming to provide to its users a monoblock structure that will combine the functions of a working table or student classroom desk with the basic functions of a personal computer united in the same working environment, dispensing with or making unnecessary the acquisition of these utensils separately and integrating all these functions into the same working environment or physical space thus becoming a total integration of all mechanical and electro-electronic components to the physical structure of the computerized table. The table has a main cover [12] with side feet [121] which will receive internally in appropriate places the computer resources [2] as central processing unit [21] as drive units, zip or floppy disks [22], multimedia unit [23], sound units [24], communication units [25], mass memory units—hard disk or Winchester [26], tension stabilizers and/or surge protectors or uninterruptable power supplies, [27] microphones, electric connections, communicators, etc. The table can be equipped with an alarm that notifies of any unauthorized movement by radio frequency or other means to a receiver.

### FIELD OF THE INVENTION

The present invention refers generally to the technology of computer equipment and educational utensils and more specifically to a particular manner of computerized table with an alarm.

The invention aims at providing initially to general users a monoblock structure, preferably automatic, which will combine the multiple functions of a working table, studying table and/or classroom desk, united in the same working environment making dispensable or unnecessary the acquisition of these utensils separately (a working table, studying desk and/or classroom desk and a personal computer). Also an aim of the present invention is a computerized table that, when an unauthorized attempt is made to move or reposition it from its respective place of installation, an alarm will be activated which through radio frequency or similar encoding will communicate the fact to whom it may concern in order that measures can be taken as required by the situation and available to that place and circumstance.

Effectively the present invention aims at a particular manner of a computerized table with alarm and attempts to characterize something totally new and able to occupy an important place when compared to the characteristics presented by all that new in the state of the art in this technological sector.

### BACKGROUND OF THE INVENTION

We know according to the state of art of the present day that when a user needs to use the resources of a computer (programs, personal software, text editors, drawings, internet, email, intranet, etc), the user must obtain a personal computer from the many models and manufactures available on the market with basically a cabinet which holds the central processing unit (CPU), drives, multimedia resources and Winchester (hard-disk—HD), and this cabinet modernly is in a rectangular or a parallel-piped shape—a tower to which are connected peripherals via connectors known as slots such as video monitors, keyboard, mouse, microphones, loudspeakers, web-cameras, communicators, printers, scanners, electric stabilizers, uninterruptable power supply or surge protector, etc.

We also know the existence of several models of furniture in which to set computer and peripheral equipment such as tables, studios, racks and general furniture where all peripheral components are placed and distributed. There are several aspects that are inconvenient. As a first inconvenience, there is the need of obtaining a personal computer and the furniture separately. This is due to the combination of functions of the personal computer and the furniture where they will be placed in the same working environment of the common physical space.

As a second inconvenience, when during the installation of the personal computer and its peripherals in the furniture where they will be exposed, there are a great amount of wires and cables that may suffer some damage besides harming the working environment aesthetically.

Objects of the Invention

Thus we aim with the present invention to characterize a particular type of computerized table with an alarm that will solve substantially the problems presented in the state of the art of this technological sector. In the same furniture or physical working space we will have integrated basic and/or advanced computer equipment and furniture to place it in, making sure that the function of a working table (to notes, reports, class notes, etc.) remains.

We aim that the computerized table according to the present invention will hold all computer electro-electronic resources such as a video monitor, keyboard/mouse, central processing unit (CPU), drives including floppy and/or zip drives, multimedia, loudspeakers, modems, hard-disk or Winchester disks, and a compact-disk recorder.

We aim that in the computerized table, the object of present invention, there is a total integration of the electric-electronic components with the physical part of the table. Therefore the integrated structure and all the wiring, previously exposed, will be placed internally in the physical part of the table unseen by the user allowing to be seen only the elements to energize the equipment, they in turn communicating with the internal hidden elements being through wire or cable.

We aim, also that in the computerized table, when the user needs to use the computer resources, and turns on or energizes the equipment starting the operating system (software), the resources will be available simultaneously, automatically and progressively, the video monitor as well as the keyboard/mouse which were previously hidden in the table.

We aim also a computerized table that, when the user does not need to use the resources of the computer anymore and switches off the equipment belonging to the computer, the equipment will be simultaneously, automatically and progressively be “kept”, “saved” or “hidden” in the structure of the table including the video monitor and keyboard/mouse previously available to the client; but now the cover of the table will be available as a working space.

We aim that, in a first constructive solution to the automatic progressive raising and lowering of the video monitor and automatic retrieving of the keyboard/mouse, be accomplished by the rotation of electric motors and structure incident to that in accommodating both the monitor and keyboard/mouse.

We aim that, in a second constructive solution, to present a compact monoblock unit, integrated with a monitor, drives (floppy or zip) and multimedia drive whose automatic progressive raising and lowering will be made through a gear adequately placed and activated rotated by an electric motor and structure in the monoblock unit.

We aim that, in a third constructive solution the availability of the video monitor is made through the sliding in an upward curved movement related to the desk cover on which it is inserted, and when it reaches its final position at the end of this movement, the keyboard/mouse will become available.

We aim yet a computerized table able to have its height regulated by the user according his biotype, and to this, a retractable foot support at the computerized table that pushed by electric motors through gears, will be expanded or retracted, respectively increasing or lowering the height of the table according to the need of the user.

We aim yet, in an optional variation, that the computerized table has a front drawer with regulated height holding the keyboard/mouse which will guarantee a perfect adjustment in the working height according to the biotype of the user thus filling all ergonomical concepts and avoiding physical damage from bad body posture while working.

We aim yet a computerized table in which is foreseen the possibility of existing slots in order to receive PCMCIA cards, wireless communication providers, via radio frequency (RF) to provide connection or access to the internet, local net, intranet, etc.

We aim yet a computerized table in which it is foreseen the possibility of operational communications between keyboard and mouse with the central processing unit (CPU) to be performed by infrared or analogous procedures.

We aim yet a computerized table that any attempt to move it or any unauthorized dislodgement from its respective place of installation will result in an alarm being activated which, through radio frequency or similar, will encode and identify the “violated” apparatus by calling attention to the fact that the table has been moved to whomever it may concern in order that correct procedures can be brought to the specific place to remedy the situation.

### BRIEF DESCRIPTION OF THE DRAWINGS

Aiming to illustrate and clarify the essence of the invention in question in the peculiar manner of the computerized table according to a preferable and basic form of manufacturing established by the applicant, we make reference to the attached drawings that integrate and support the present descriptive report. Nonetheless, the present invention of a computerized table shall not be limited to this only form of characterization and accomplishment since other forms of manufacturing which do not digress from the scope of present invention must be considered. The scope of the present invention is not limited to the illustrations and description herein.

Thus:

in FIG. 1, we have frontally represented schematically and illustratively the particular manner of the computerized table represented by the present invention showing exactly as it is presented to the user when such a user does not need to use the computer resources;

in FIG. 2 we have a side view represented schematically and illustratively of the computerized table portrayed in the previous figures;

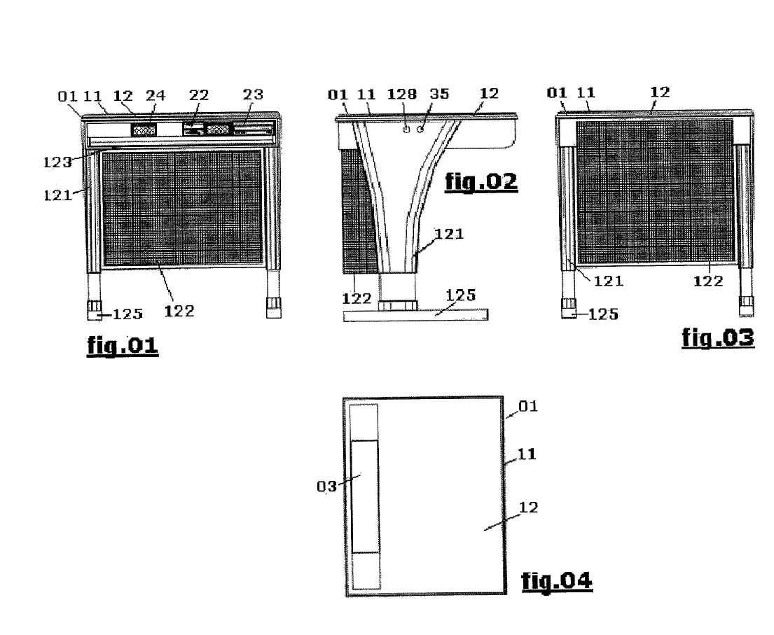

in FIG. 3 we have a back side view represented schematically and illustratively of the computerized table portrayed in the previous figures;

in FIG. 4 we have an upper side view represented schematically and illustratively of the computerized table portrayed in the previous drawings having an orthogonal projection on the basis of FIG. 2;

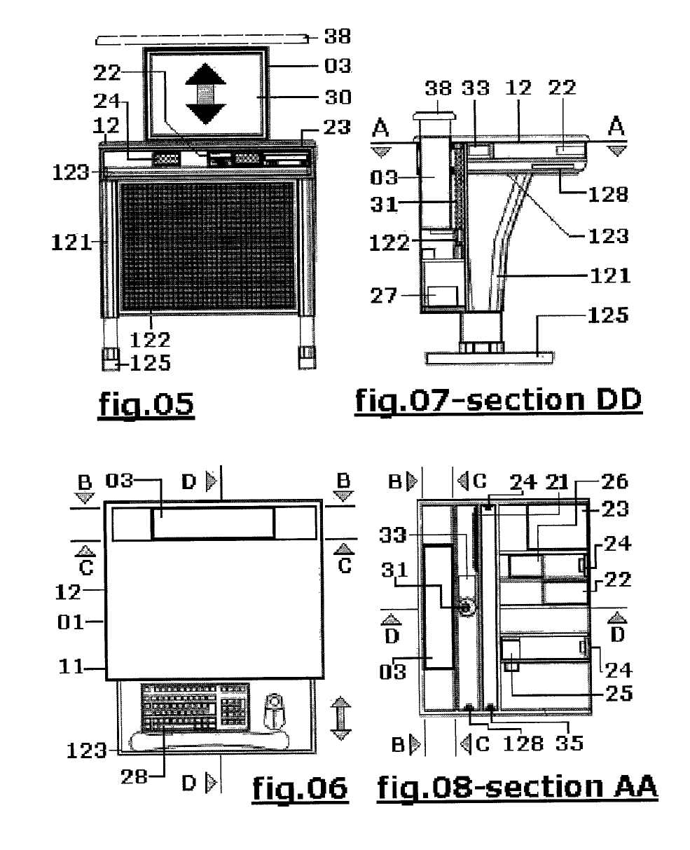

in FIG. 5 we have a frontal view represented schematically and illustratively of the computerized table portrayed in the previous figures and exactly as shown on FIG. 1, but this time, the video monitor is in an elevated position with respect to the table cover; we call to the attention in this figure to the possibility that an upper shelf be in synchrony to receive printers, scanners, and other peripherals;

in FIG. 6 we have represented an upper view schematically and illustratively of the computerized table as shown in the FIG. 4, but now with the mouse/keyboard becoming available to be used by the user;

in FIG. 7 we have a side view represented schematically and representatively of the computerized table, accomplished according the cut lines “DD” referred to in FIG. 6 as well as FIG. 8;

in FIG. 8 we have represented schematically and illustratively a section view of the computerized table accomplished according to the cut line “AA”, referred to in FIG. 7;

in FIG. 9 we have represented schematically and illustratively a section view of a computerized table accomplished according the cut line “BB”, referred in FIG. 6 portraying the video monitor in the beginning of the raised position (beginning of the motion of rising);

in FIG. 10 we have represented a view schematically and illustratively a section view of the computerized table accomplish according to the cut line “BB” as referred in FIG. 6 portraying the video monitor in the raised position (end of the motion of rising);

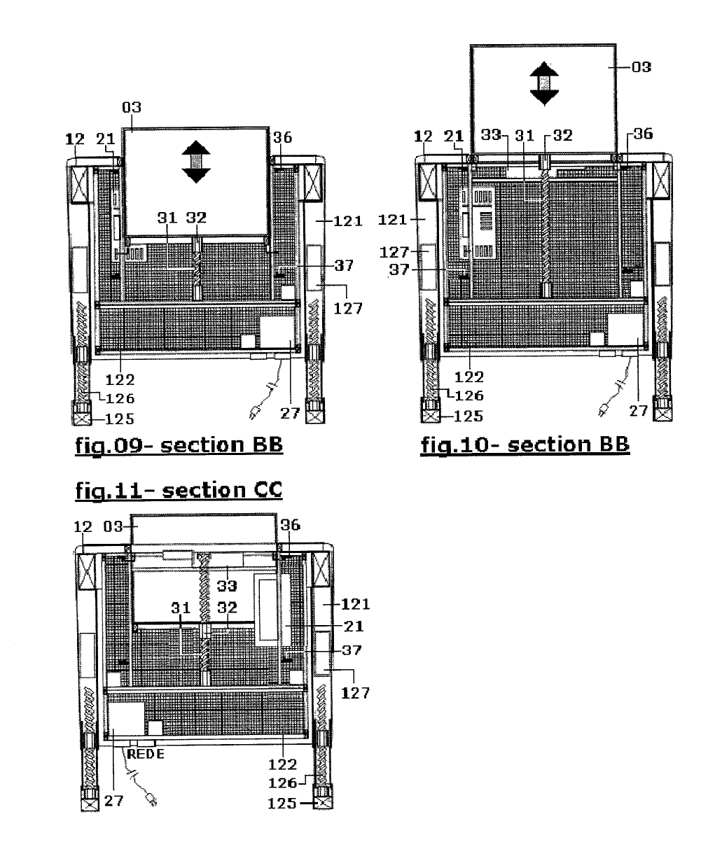

in FIG. 11 we have represented a section view schematically and illustratively of the computerized table accomplished according to the cut line “CC” as referred in FIG. 6 portraying the front view of the raising/lowering mechanisms of the video monitor;

in FIG. 12 we have represented a front view schematically and illustratively of a computerized table according to the present invention, but this time portraying a constructive optional variation in which the LCD video monitor is inserted in the main table cover and is set at the disposition of the user through the appropriate sliding in an upward curved movement;

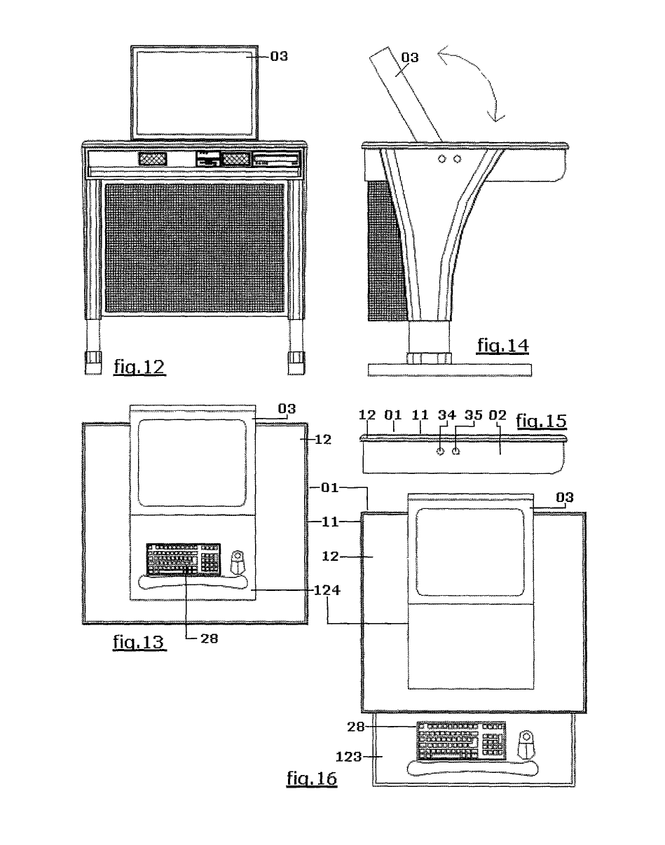

in FIG. 13 we have represented an upper view schematically and illustratively of the computerized table referring to the previous figure, portraying the availability of the keyboard/mouse to the user after the sliding movement of the video monitor as related to the main table cover;

in FIG. 14 we have represented a side view, of the computerized table referring to FIGS. 12 and 13;

in FIG. 15 we have a side view schematically and illustrative of the computerized table according to the present invention portraying an optional feature of a brief case specific to transportation and storage;

in FIG. 16 we have an upper view schematically and illustratively of the computerized table portraying another optional feature on which the monitor is simply built into the table cover of the main table on which the keyboard/mouse are made available through a sliding shelf;

in FIG. 17 we have represented a side view in perspective, schematically and illustratively portraying a compact monoblock unit integrated by the monitor, drives and multimedia foreseen as a constructive variation to the computerized table according to the present invention;

in FIG. 18 we have represented a side view according to a cut schematically and illustrative showing the raising/lowering mechanisms of the compact monoblock unit as portrayed in the previous figure;

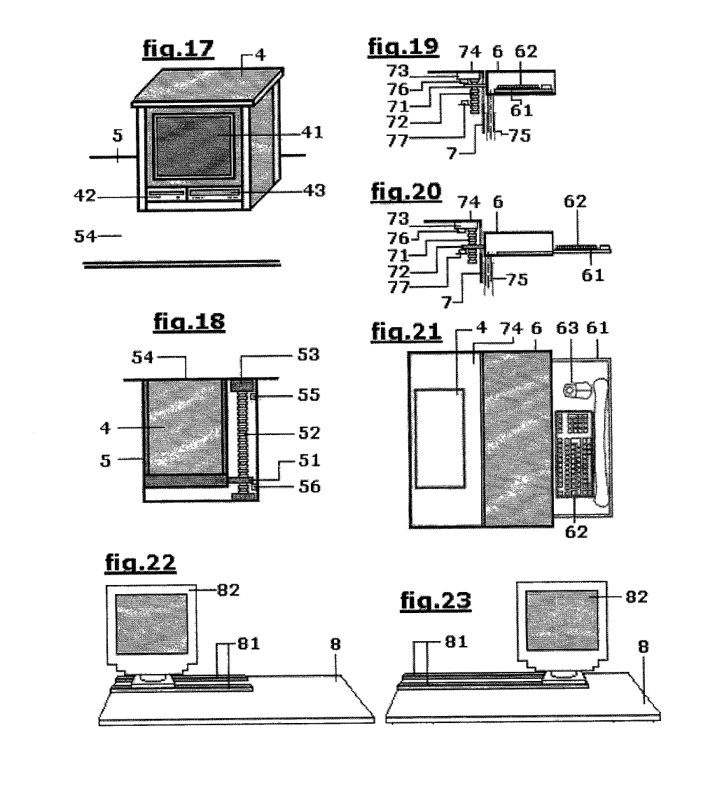

in FIG. 19 we have a side view represented schematically and illustratively according to the cut showing a compartment with a keyboard/mouse movable shelf able to regulate the height through a rotating worm gear either on clockwise or counter-clockwise direction according to a constructive variation of the present invention;

in FIG. 20 we have represented a side view schematically and illustrative as the previous figure, but this time showing the height regulation of the fixed compartment as well as making available the keyboard and mouse to the user;

in FIG. 21 we have an upper view schematically and illustratively regarding to the previous figures showing the availability through horizontal movement of the mobile shelf;

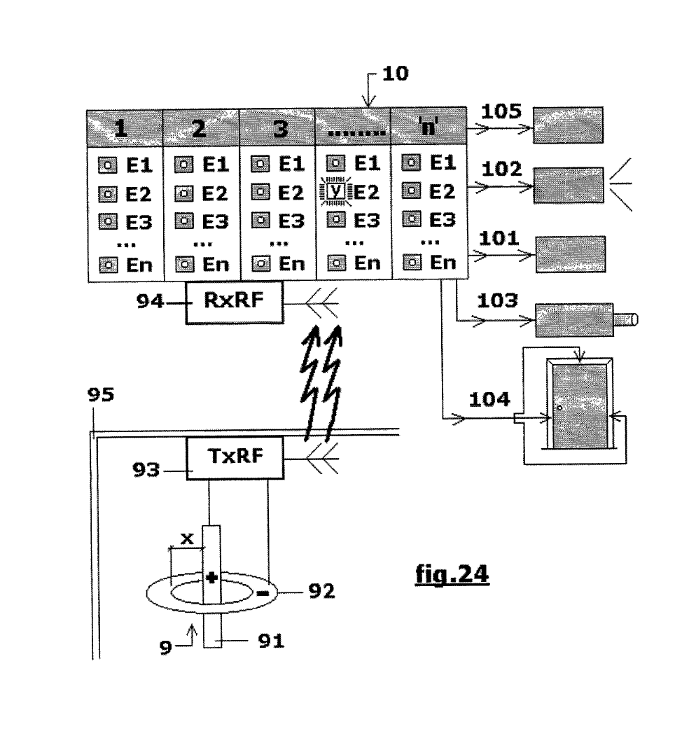

in FIG. 22 we have a view in perspective schematically and illustratively of a constructive variation in which the video monitor is installed on mechanisms over tracks on the top of the table cover being placed on the left side of the desk cover;

in FIG. 23 we have represented a view in perspective schematically and illustratively such as in the previous figure, but this time being able to use the personal computer components and showing the video monitor displaced to the right side of the table cover through installed track mechanisms; and lastly:

in FIG. 24, we have an operational schematic depicting the safety alarm indicating its method of operation as well as the main components responsible for its functionality as well as their installation in the interior of the computerized table.

Although the present computerized table with alarm is described by the embodiments presented, it will be understood that the invention shall not be limited simply by these embodiments. To the contrary, all alternatives, variations and equivalent modifications might be included in the spirit and scope of the present invention.

### DETAILED DESCRIPTION OF THE INVENTION

As it can be deduced by the analysis of the figures, the particular construction of the computerized table with alarm according to the present invention is characterized by having basically and essentially a monoblock structure [1] that integrates and combines the multiple functions of a working table, a studying desk and/or classroom desk [11] with the basic functions and/or advanced of a personal computer [2] united and integrated in the same working environment or physical space, with a full integration of the mechanical and electro-electronic components with the physical structure of the computer science table. The computerized table, according to the present invention, is characterized by having a main cover structure [12] with side feet [121] and with a frame back-lowered cabinet [122] which receives internally, in appropriated and pre-specified places, the installation of electric-electronic computer resources [2] such as a central processing unit (CPU) [21], floppy disk/zip drives [22], multimedia unit [23], units for sound [24], communication modem units [23], mass memory unit—hard drive or Winchester [26], tension stabilizer units and/or no breaks [27], microphones, electrical connections, communications, etc.

The present invention is characterized by a main cover [12], which has a built-in video monitor preferentially LCD [3] internally in the space occupied by the back-lowered frame [122], which is able to accomplish vertical movements—raising and lowering—through a rotation in either direction of a worm gear [31] able to rotate inside of a support [32] attached to the enclosure of the monitor frame [3] with the rotational movement provided by an electric motor [33] operated when the equipment is turned on through switch [34], thus starting its operating system or through a specific switch [35] on the monitor [3]. The computerized table here, characterized by the raising and lowering of the video monitor [3], has its range controlled through position sensors that limit the maximum range—upper [36] and lower [37], and which automatically stop the rotating movement of the worm gear [31] through the electrical motor [33].

The computerized table according to the present invention is characterized by the cover [12] facing the framed cabinet [122] with a lower mobile sliding cover [123]. The accommodation of the keyboard/mouse [28] is able to move manually with the movement of the video monitor [3] also with limit sensors for retraction and expansion.

The computerized table here characterized by the fact that optionally the structure of said video monitor [3] could be placed in an upper shelf [38] that will follow its movements, could be or not be built-in the main cover [12], and the same for the printer, scanner and other peripherals.

The computerized table as advocated by the present invention is characterized by having, according a constructive variation, a support structure [4] in which are properly installed a video monitor [41] of any type or model, drives [42] for floppy and zip disks, and multimedia drives [43]. The structure [4], internal to the cabinet [5], is associated through an activation support device [51] to a vertical gear [52] duly activated either in clockwise or counter-clockwise rotation by an activation motor [53], the maximum limits of the opening and closure of the structure [1] being related to the cover [54] are controlled by sensors—upper [55] and lower [56].

The computerized table according to the present invention is also characterized by the fact seen in a constructive optional variation with the possibility of a LCD [3] video having its opening or surface facade [30] totally built into the main cover [12] and being available to the user through the automatic movement related to the cover [12], also being available to the user with the final course of the movement of the keyboard/mouse [28] from the totally built-in receptacle [124] seen in the main cover[12], and placed so that the lower sliding cover [123] accommodates the keyboard/mouse.

The computerized table as advocated by the present invention characterized by the fact seen in an optional constructive variation as the possibility of a LCD [3] video monitor being built into the receptacle [124], it being available to the user through its automatic movement related to the cover [12] while the keyboard/mouse [28] will stay on the lower sliding cover [123] of the accommodation. The computerized table here is characterized by the fact that, in this video monitor movement constructive variation [3], this movement might be either automatic and electric through an electric motor acting in the movement axle (option not represented in the previous figures) or by the manual release of mechanical locks associated with pneumatic pistons (this option also not represented in the figures)—that will provide a small elevation of the built-in video monitor [30] related to the cover [12] with the purpose to the user to manually move it until the end of the track.

The computerized table of the present invention characterized by the fact that in this construction of the video monitor [3] movement, the possibility is foreseen of not having support feet in order to create a configuration as a kind of a briefcase for transportation and/or storage The computerized table here characterized by the fact that the LCD video monitor [3], as well as in the basic constructive variation,—as a lift—as in the optional movement variation, might occupy several positions in said main cover [12], still keeping the characteristic of remaining hidden to the user when the resources of computer [2] are not being used.

The invention here characterized by the fact that the possibility is foreseen of there being slots receiving PCMCIA cards as providers of wireless communications, via radio frequency to connect or access to the internet, local net, intranet, etc.

The invention is characterized by the fact that the possibility is foreseen of operational communication between keyboard/mouse [28] with the central processing unit [21] being placed internally to the main cover [12] and be accomplished by infrared or a similar technique.

The computerized table according to the present invention characterized to foresee the height regulation of the table through retractable supports [125], vertically activated, and ascending or descending through the rotation of worm gears [126] activated by electric motors [127] which are energized by a specific switch [128]. The computerized table also characterized by the reversal of the worm gear's rotation [126] up to the moment the user finds the height compatible to his biotype. The computerized table is characterized by having optionally a fixed compartment [6] which in its interior there is a mobile shelf [61] to place the keyboard [62] and mouse [63] on, and internal to the cabinet [7], compartment [6] is found associated through an activating support device [71] of a vertical gear [72], duly activated either in the clockwise or counter-clockwise direction by an activating motor [73] with the maximum and minimum height of this compartment [6] related to the cover [74] duly guided and structured [75] controlled by the upper [76] and lower [77] sensors.

The computerized table advocated by the present invention is also characterized by having optionally a cover [8] on which the rear part has a track mechanism [81] on which the video monitor [82] is installed making a sliding and dislodgement along the cover [8] from side-to-side (left to right, etc.).

The computerized table is also characterized by having an electronic security alarm with a basic and essentially movement sensor module [9] with a pendulum [91] polarized positively (+), placed in the center of a frame [92] polarized negatively (−), and a space (x) between to sense impact or movement. The sensor attempts to sense a dislodgement or strong impact whose action will cause contact between the pendulum [91] and frame [92] activating a radio frequency [93] transmitter, whereby encoded signals will activate a radio frequency [94] receiver which will be properly monitored. As it is sensitized, the receiver of the radio frequency [94] may, among many other possibilities as technically feasible, be activated by a central monitoring module [10], identifying that the machine was violated [95] and its location (y), and that automatically or manually will be able to activate a visual signal [101] and/or sound [102] and/or activate a video camera [103] and/or activate the remote electronic locking of the door of the environment [104] and/or call the competent police authorities [105] It should be noted that the polarities on the pendulum/frame can be reversed. without affecting the functioning of the present invention. It should also be noted that any type of impact or motion sensor is within the scope of the present invention to detect any attempt to move or jar the table. Also, any means of communicating the fact that the table has been moved or impacted to a remote location is within the scope of the present inventionl.

We have attempted in the present invention of a computerized table with alarm to present as was evident by the analyses done, together with the attached figures, the support of new characteristics relative to all that is new in the state of the technique of this technological sector.

I claim:

1. A computerized table of integrated monoblock structure comprising, in combination:
a personal computer stored in said table with a monitor;
a flat top surface used as a writing surface;
an actuator means for raising and lowering said monitor;
said monitor being raised by said actuator means for use of said personal computer and lowered by said actuator means for use of said flat top surface as a writing surface, said actuator means being activated by switching said personal computer on or off.

2. The computerized table of claim 1 further comprising a keyboard and mouse also stored in said table with means for making said keyboard and mouse available for use of said personal computer.

3. The computerized table of claim 1 further comprising a main cover with side feet and a framed lower rear cabinet which will hold internally in a predetermined location all electronic components of a personal computer including a central processing unit, disk drives, multimedia resources, sound units, and communication modems.

4. The computerized table of claim 1 said video monitor is driven upward and downward by action of a worm gear in communication with an electric motor.

5. The computerized table of claim 4 wherein said electric motor is activated by a switch that simultaneously activates said personal computer.

6. The computerized table of claim 4 further comprising limit switches for limiting the range of vertical motion of said monitor.

7. The computerized table of claim 2 wherein said means for making said keyboard and mouse available for use is a second shelf synchronized with said monitor.

8. The computerized table of claim 7 wherein said shelf can also hold a printer.

9. The computerized table of claim 1 wherein said monitor has an opening surface built into said flat top surface.

10. The computerized table of claim 1 wherein said actuator means is at least one pneumatic piston.

11. The computerized table of claim 1 wherein said table folds into a brief-case configuration for transportation or storage.

12. The computerized table of claim 1 wherein said monitor is a liquid crystal display (LCD).

13. The computerized table of claim 1 further comprising a motion sensor coupled to a radio transmitter, said radio transmitter communicating any unauthorized motion of said table as an alarm.

14. The computerized table of claim 1 wherein said activation means adjusts said monitor vertically to suit a particular user.

15. The computerized table of claim 1 further comprising slots for receiving PCMCIA cards.

16. The computerized table of claim 2 wherein said keyboard and mouse communicate with said personal computer optically.

17. The computerized table of claim 1 wherein said monitor is coupled to a track mechanism to achieve left-right lateral movement.

18. The computerized table of claim 13 wherein said motion sensor is a pendulum.

19. A table designed to be used as both a writing surface and a computer console of the type that resembles a piece of furniture comprising a table frame with a compartment for storing a personal computer, a flat writing surface that can be displaced when said personal computer is used, an actuator mechanism for raising and lowering a video monitor into position for a user, a mouse and keyboard which are also raised and lowered by said actuator, and an alarm motion detection system that detects unauthorized movements of said table and transmits them to a receiver for proper response.

20. The table of claim 19 wherein said actuator is at least one worm gear driven by an electric motor.
